(19) United States
(12) Patent Application Publication
(10) Pub. No.: US 2015/0151504 A1
(43) Pub. Date: Jun. 4, 2015

(54) PLASTIC BEZEL

(71) Applicants: Inventec (Pudong) Technology Corporation, Shanghai (CN); INVENTEC CORPORATION, Taipei City (TW)

(72) Inventors: Chun-Ying YANG, TAIPEI CITY (TW); Ying-Chao PENG, TAIPEI CITY (TW); Chi-Cheng HSIAO, TAIPEI CITY (TW)

(73) Assignees: INVENTEC CORPORATION, Taipei City (TW); Inventec (Pudong) Technology Corporation, Shanghai (CN)

(21) Appl. No.: 14/229,984

(22) Filed: Mar. 30, 2014

(30) Foreign Application Priority Data
Nov. 29, 2013 (CN) 201310629969.0

(51) Int. Cl. B32B 3/26

(52) U.S. Cl. CPC B32B 3/266

(57) ABSTRACT

A plastic bezel is disclosed. The plastic bezel includes a plate body and a plurality of bosses connected to the plate body. The plate body has a plate thickness. Each of the bosses has an opening and an accommodating hole inwardly formed from the opening. The accommodating hole is configured to engage an insert nut of which the type is #6-32. Each of the bosses has a wall thickness. The wall thickness is equal to or larger than 1.5 mm, and the plate thickness is 1.6-2 times of the wall thickness.

### RELATED APPLICATIONS

This application claims priority to Chinese Application Serial Number 201310629969.0, filed Nov. 29, 2013, which is herein incorporated by reference.

### BACKGROUND

1. Technical Field

The present disclosure relates to a plastic bezel.

2. Description of Related Art

In general, the most common method of mounting two plastic pieces of an electronic product during assembly processes is firstly embedding an insert nut into a boss of one of the plastic pieces by heat stacking or insert molding, in which the texture at the outer surface of the insert nut can increase the bonding strength between the insert nut and the boss. And then, a screw can be used to pass through a through hole of another plastic piece and fastened to the insert nut, so that the two plastic pieces can be fastened to each other.

However, before the processes of heat stacking or insert molding the insert nut into the boss, the wall thickness of the boss must meet certain specifications. If the wall thickness is not thick enough, the boss cannot securely fix the insert nut, which may make the screw fastened to the boss be easily loosened (because the tensile capacity and the torsional capacity are insufficient) and unable to achieve the purpose of fastening the plastic pieces.

Furthermore, a common electronic product usually uses many types of insert nuts, so the electronic product correspondingly has many different types of bosses. If the types of the used insert nuts are not unified, it is difficult to make the performances of all bosses meet the recommended specifications of tensile strength and torsional strength.

### SUMMARY

The disclosure provides a plastic bezel. The plastic bezel includes a plate body and a plurality of bosses. The plate body has a plate thickness. The bosses are connected to the plate body. Each of the bosses has an opening and an accommodating hole. The accommodating hole is inwardly formed from the opening. The accommodating hole is configured to engage an insert nut of which the type is #6-32. Each of the bosses has a wall thickness. The wall thickness is equal to or larger than 1.5 mm. The plate thickness is 1.6-2 times of the wall thickness.

In an embodiment of the disclosure, each of the bosses has an outer diameter and an inner diameter. The outer diameter is equal to or larger than 8 mm. The inner diameter is equal to or smaller than 5 mm.

In an embodiment of the disclosure, each of the bosses has a wall height relative to the plate body. The wall height is larger than a length of the insert nut in a direction of an axis of the insert nut.

In an embodiment of the disclosure, the opening has a chamfer. The chamfer has a horizontal width in a horizontal direction parallel to the plate body and a vertical height in a vertical direction perpendicular to the plate body. The horizontal width is equal to the vertical height.

In an embodiment of the disclosure, the horizontal width and the vertical height are substantially 0.3 mm.

In an embodiment of the disclosure, an inner wall of the accommodating hole has a counterbored portion inwardly formed from the opening.

In an embodiment of the disclosure, the counterbored portion has a horizontal width in a horizontal direction parallel to the plate body and a vertical depth in a vertical direction perpendicular to the plate body. The horizontal width is substantially 5.64 mm. The vertical depth is substantially 0.3 mm.

In an embodiment of the disclosure, the wall thickness is further equal to or larger than 1.8 mm.

In an embodiment of the disclosure, each of the bosses has an outer diameter and an inner diameter. The outer diameter is equal to or larger than 8.4 mm. The inner diameter is equal to or smaller than 4.8 mm.

In an embodiment of the disclosure, each of the bosses has a wall height relative to the plate body. The wall height is equal to or larger than 4.2 mm.

Accordingly, the bosses included by the plastic bezel of the disclosure are unified to be configured to fix with the insert nut of which the type is #6-32, so not only can the complexity of the plastic bezel be reduced, but also the performances of all bosses after insert molding can be exactly handled. Furthermore, in order to expand the use of the insert nut in the processes of heat stacking, the disclosure provides different designs of bosses correspondingly. Therefore, it can be seen that the plastic bezel of the disclosure can be effectively used in the processes of insert molding and the processes of heat stacking, and can entirely meet the recommended specifications of tensile strength and torsional strength.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is an exploded view of a plastic bezel, an insert nut, a structural member, and a screw according to an embodiment of the disclosure;

FIG. 2A is a top view of the insert nut in FIG. 1;

FIG. 2B is a side view of the insert nut in FIG. 1;

FIG. 3 is a cross-sectional view of FIG. 2B along line 3-3′;

FIG. 4 is a partial cross-sectional view of the plastic bezel in FIG. 1;

FIG. 5 is a partial cross-sectional view of a plastic bezel according to another embodiment of the disclosure;

FIG. 6 is a partial enlarged view of FIG. 5;

FIG. 7 is a partial cross-sectional view of a plastic bezel according to another embodiment of the disclosure; and

FIG. 8 is a partial enlarged view of FIG. 7.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

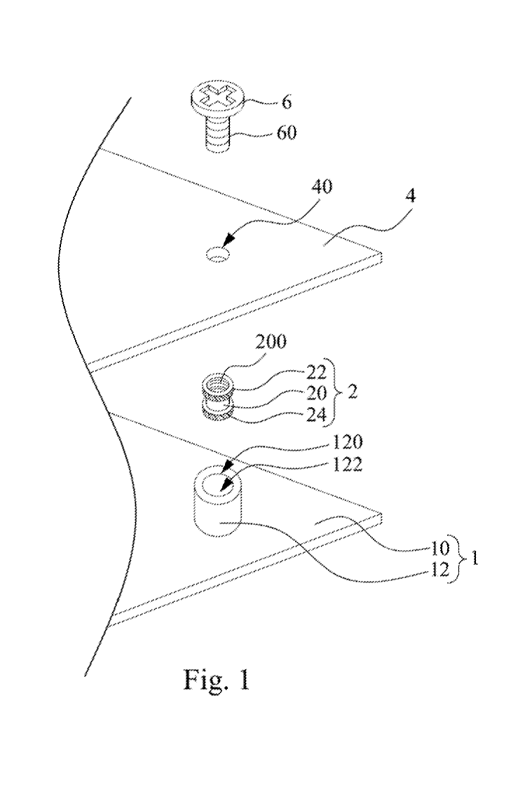

FIG. 1 is an exploded view of a plastic bezel 1, an insert nut 2, a structural member 4, and a screw 6 according to an embodiment of the disclosure.

As shown in FIG. 1, the plastic bezel 1 includes a plate body 10 and a plurality of bosses 12 (FIG. 1 only shows a single boss 12). The bosses 12 of the plastic bezel 1 are connected to the plate body 10. Each of the bosses 12 of the plastic bezel 1 has an opening 120 and an accommodating hole 122. The accommodating hole 122 is inwardly formed from the opening 120. The accommodating hole 122 is configured to engage the insert nut 2 (e.g., by insert molding or heat stacking). The insert nut 2 has an internal threaded portion 200. The structural member 4 has a through hole 40 configured for the external threaded portion 60 of the screw 6 to pass to pass through. According to the aforementioned configuration, after the external threaded portion 60 of the screw 6 passes through the through hole 40 of the structural member 4 and is fastened to the internal threaded portion 200 of the insert nut 2, the screw 6 can achieve the purpose of fastening the plastic bezel 1 and the structural member 4. The structure and sizes of the insert nut 2 are described in detail below.

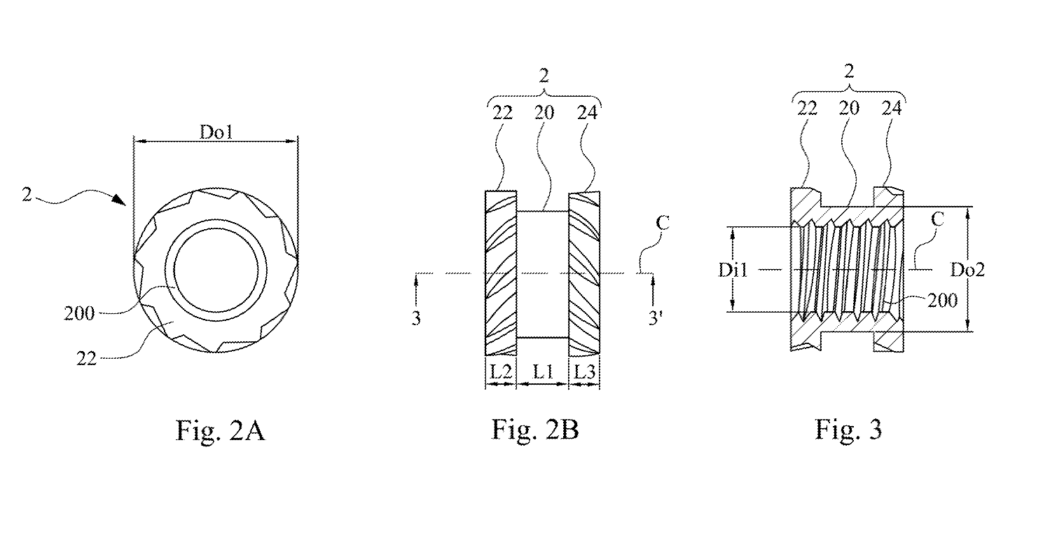

FIG. 2A is a top view of the insert nut 2 in FIG. 1. FIG. 2B is a side view of the insert nut 2 in FIG. 1. FIG. 3 is a cross-sectional view of FIG. 2B along line 3-3.

As shown in FIG. 2A to FIG. 3, the type of the insert nut 2 that is configured to engage the boss 12 on the plastic bezel 1 is #6-32. The insert nut 2 includes a hollow body 20, a first flange portion 22, and a second flange portion 24. The insert nut 2 has an axis C. The internal threaded portion 200 of the insert nut 2 is formed at the inner wall of the hollow body 20. The first flange portion 22 and the second flange portion 24 of the insert nut 2 are respectively connected at two ends of the hollow body 20 and outwardly extended relative to the axis C. The peripheral surfaces of the first flange portion 22 and the second flange portion 24 have textures, and the forming directions of the textures are different, so that the bonding strength between the insert nut 2 and the boss 12 can be increased.

Furthermore, as shown in FIG. 2A and FIG. 3, the outer diameter Do1 of the first flange 22 and the second flange 24 of the insert nut 2 is substantially 5.44 mm. The outer diameter Do2 of the hollow body 20 of the insert nut 2 is substantially 4.2±0.07 mm. The minor diameter Di1 (i.e., the minimum diameter) of the internal threaded portion 200 is substantially 2.799-2.896 mm.

As shown in FIG. 2B, in the direction of the axis C, the length L1 of the hollow body 20 of the insert nut 2 is substantially 1.8 mm, and both of the length L2 of the first flange portion 22 and the length L3 of the second flange portion 24 are substantially 1 mm. In other words, the length Ls of the insert nut 2 in the direction of the axis C is substantially 3.8 mm.

The plastic bezel 1 of the embodiment uniformly adopts the insert nut 2 of which the type is #6-32, so the complexity of the plastic bezel 1 can be reduced. The structure and sizes of the boss 12 are described in detail below.

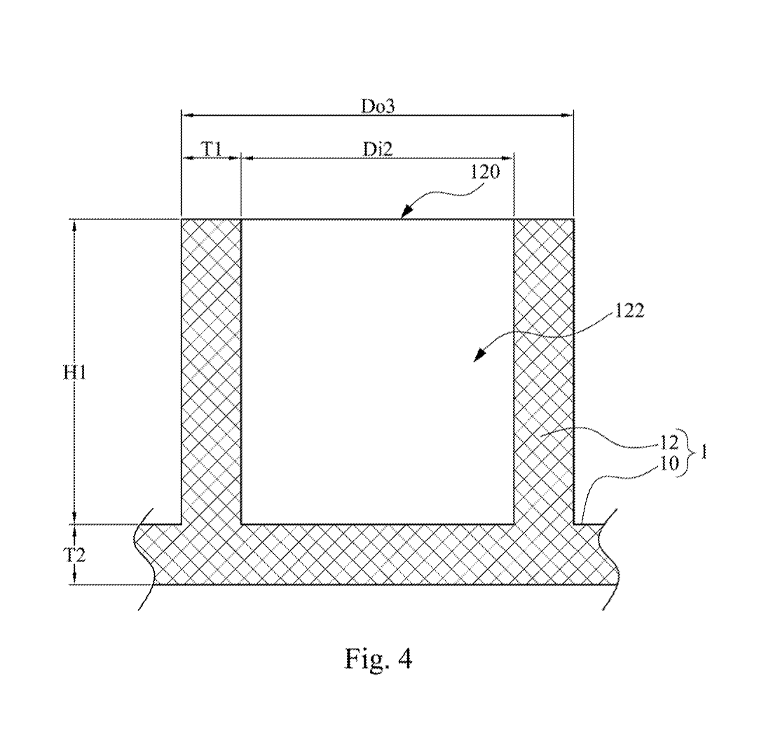

FIG. 4 is a partial cross-sectional view of the plastic bezel 1 in FIG. 1.

In the embodiment of the disclosure, the bosses 12 of the plastic bezel 1 are designed to engage the insert nut 2 by insert molding. As shown in FIG. 4, each of the bosses 12 of the plastic bezel 1 has a wall thickness T1. The plate body 10 of the plastic bezel 1 has a plate thickness T2. In order to make all of the bosses 12 meet the recommended specifications of tensile strength and torsional strength, the wall thickness T1 of the bosses 12 is equal to or larger than 1.8 mm, and the plate thickness T2 is 1.6-2 times of the wall thickness T1.

Furthermore, as shown in FIG. 4, each of the bosses 12 of the plastic bezel 1 has an outer diameter Do3 and an inner diameter Di2. The outer diameter Do3 of the bosses 12 is equal to or larger than 8.4 mm. The inner diameter Di2 of the bosses 12 is equal to or smaller than 4.8 mm. Each of the bosses 12 of the plastic bezel 1 has a wall height H1 relative to the plate body 10. The wall height H1 of the bosses 12 is equal to or larger than 4.2 mm.

According to the aforementioned configuration, after the practical tension and torsion tests, it can be seen that the maximum pulling force the engaged insert nut 2 and the boss 12 can bear is about 187-200 kgf, and the maximum torsional force the engaged insert nut 2 and the boss 12 can bear is about 29-42 kgf-cm, which are far more than the recommended specifications of tensile strength and torsional strength.

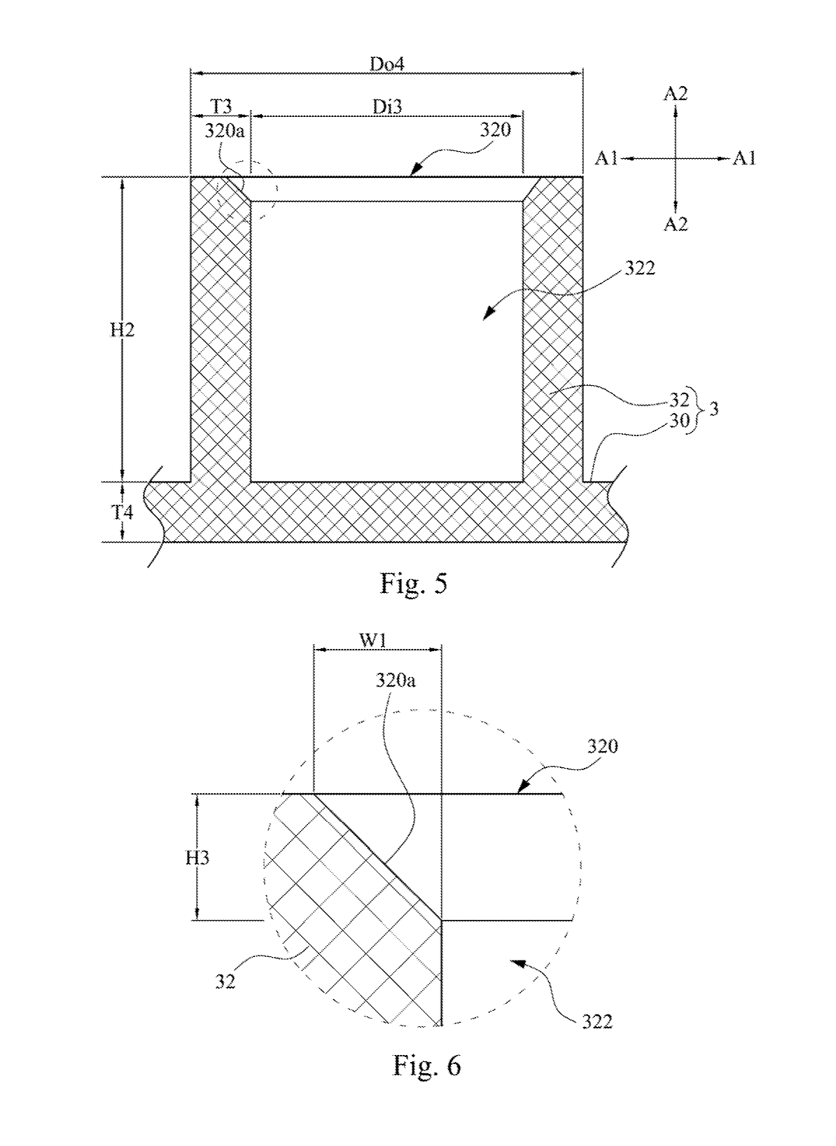

FIG. 5 is a partial cross-sectional view of a plastic bezel 3 according to another embodiment of the disclosure. FIG. 6 is a partial enlarged view of FIG. 5.

In the embodiment of the disclosure, the bosses 32 of the plastic bezel 3 are designed to engage the insert nut 2 by heat stacking. As shown in FIG. 5 and FIG. 6, each of the bosses 32 of the plastic bezel 3 has a wall thickness T3. The plate body 30 of the plastic bezel 3 has a plate thickness T4. In order to make all of the bosses 32 meet the recommended specifications of tensile strength and torsional strength, the wall thickness T3 of the bosses 32 is equal to or larger than 1.5 mm, and the plate thickness T4 of the plate body 30 is 1.6-2 times of the wall thickness T3.

Furthermore, as shown in FIG. 5, each of the bosses 32 of the plastic bezel 3 has an outer diameter Do4 and an inner diameter Di3. The outer diameter Do4 of the bosses 32 is equal to or larger than 8 mm. The inner diameter Di3 of the bosses 32 is equal to or smaller than 5 mm. Each of the bosses 32 of the plastic bezel 3 has a wall height H2 relative to the plate body 30. The wall height H2 of the bosses 52 is larger than the length Ls (i.e., larger than 3.8 mm) of the insert nut 2 in the direction of the axis C of the insert nut 2.

In addition, as shown in FIG. 6, the opening 320 of each of the bosses 32 has a chamfer 320a. The chamfer 320a has a horizontal width W1 in a horizontal direction A1 parallel to the plate body 30 and a vertical height H3 in a vertical direction A2 perpendicular to the plate body 30. The horizontal width W1 of the chamfer 320a is equal to the vertical height H3. Hence, during the processes of heat stacking, the insert nut 2 can be easily inserted into the accommodating hole 322 from the opening 320 of each of the bosses 32.

In the embodiment of the disclosure, the horizontal width W1 and the vertical height H3 of the chamfer 320a are substantially 0.3 mm, but the disclosure is not limited in this regard.

According to the aforementioned configuration, during the practical tension test, it can be seen that after the engaged insert nut 2 and the boss 32 bear the pulling force exceeding the recommended value (e.g., 290 lbs), even though the testing rivet has fallen off, the insert nut 2 and the boss 32 are still not corrupted and deformed. During the practical torsion test, it can be seen that after the engaged insert nut 2 and the boss 32 bear the torsion force exceeding the recommended value (e.g., 7.5 in-lbs), the insert nut 2 does not fall off from the boss 32 or slide relative to the boss 32.

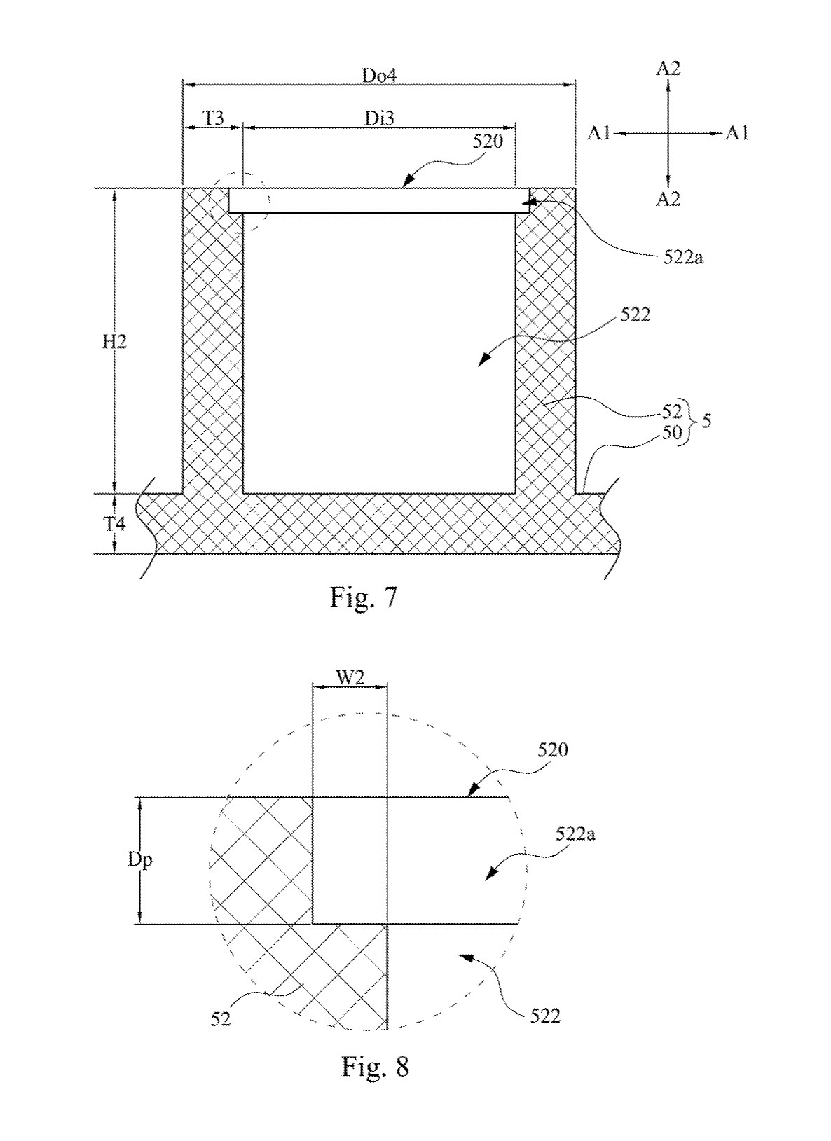

FIG. 7 is a partial cross-sectional view of a plastic bezel 5 according to another embodiment of the disclosure. FIG. 8 is a partial enlarged view of FIG. 7.

In the embodiment of the disclosure, the bosses 52 of the plastic bezel 5 are designed to engage the insert nut 2 by heat stacking. As shown in FIG. 7 and FIG. 8, each of the bosses 52 of the plastic bezel 5 has a wall thickness T3. The plate body 50 of the plastic bezel 5 has a plate thickness T4. In order to make all of the bosses 52 meet the recommended specifications of tensile strength and torsional strength, the wall thickness T3 of the bosses 52 is equal to or larger than 1.5 mm, and the plate thickness T4 of the plate body 50 is 1.6-2 times of the wall thickness T3.

Furthermore, as shown in FIG. 7, each of the bosses 52 of the plastic bezel 5 has an outer diameter Do4 and an inner diameter Di3. The outer diameter Do4 of the bosses 52 is equal to or larger than 8 mm. The inner diameter Di3 of the bosses 52 is equal to or smaller than 5 mm. Each of the bosses 52 of the plastic bezel 5 has a wall height H2 relative to the plate body 50. The wall height H2 of the bosses 52 is larger than the length Ls (i.e., larger than 3.8 mm) of the insert nut 2 in the direction of the axis C of the insert nut 2.

In addition, as shown in FIG. 8, an inner wall of the accommodating hole 522 of each of the bosses 52 has a counterbored portion 522a. The counterbored portion 522a of the accommodating hole 522 is inwardly formed from the opening 520. The counterbored portion 522a has a horizontal width W2 in a horizontal direction A1 parallel to the plate body 50 and a vertical depth Dp in a vertical direction A2 perpendicular to the plate body 50. The horizontal width W2 of the counterbored portion 522a is substantially 5.64 mm (i.e., the outer diameter Do1 of the first flange portion 22 and the second flange portion 24 of the insert nut 2 adds 0.02 mm). The vertical depth Dp is substantially 0.3 mm. Hence, during the processes of heat stacking, the insert nut 2 can be easily inserted into the accommodating hole 522 from the opening 520 of each of the bosses 52.

According to the aforementioned configuration, during the practical tension test, it can be seen that after the engaged insert nut 2 and the boss 52 bear the pulling force exceeding the recommended value (e.g., 290 lbs), even though the testing rivet has fallen off, the insert nut 2 and the boss 52 are still not corrupted and deformed. During the practical torsion test, it can be seen that after the engaged insert nut 2 and the boss 52 bear the torsion force exceeding the recommended value (e.g., 7.5 in-lbs), the insert nut 2 does not fall off from the boss 52 or slide relative to the boss 52.

According to the foregoing recitations of the embodiments of the disclosure, it can be seen that the bosses included by the plastic bezel of the disclosure are unified to be configured to fix with the insert nut of which the type is #6-32, so not only can the complexity of the plastic bezel be reduced, but also the performances of all bosses after insert molding can be exactly handled. Furthermore, in order to expand the use of the insert nut in the processes of heat stacking, the disclosure provides different designs of bosses correspondingly. Therefore, it can be seen that the plastic bezel of the disclosure can be effectively used in the processes of insert molding and the processes of heat stacking, and can entirely meet the recommended specifications of tensile strength and torsional strength.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A plastic bezel, comprising:
a plate body having a plate thickness; and
a plurality of bosses connected to the plate body, each of the bosses having an opening and an accommodating hole inwardly formed from the opening, the accommodating hole being configured to engage an insert nut of which the type is #6-32, wherein each of the bosses has a wall thickness, the wall thickness is equal to or larger than 1.5 mm, and the plate thickness is 1.6-2 times of the wall thickness.

2. The plastic bezel of claim 1, wherein each of the bosses has an outer diameter and an inner diameter, the outer diameter is equal to or larger than 8 mm, and the inner diameter is equal to or smaller than 5 mm.

3. The plastic bezel of claim 2, wherein each of the bosses has a wall height relative to the plate body, and the wall height is larger than a length of the insert nut in a direction of an axis of the insert nut.

4. The plastic bezel of claim 3, wherein the opening has a chamfer, the chamfer has a horizontal width in a horizontal direction parallel to the plate body and a vertical height in a vertical direction perpendicular to the plate body, and the horizontal width is equal to the vertical height.

5. The plastic bezel of claim 4, wherein the horizontal width and the vertical height are substantially 0.3 mm.

6. The plastic bezel of claim 3, wherein an inner wall of the accommodating hole has a counterbored portion inwardly formed from the opening.

7. The plastic bezel of claim 6, wherein the counterbored portion has a horizontal width in a horizontal direction parallel to the plate body and a vertical depth in a vertical direction perpendicular to the plate body, the horizontal width is substantially 5.64 mm, and the vertical depth is substantially 0.3 mm.

8. The plastic bezel of claim 1, wherein the wall thickness is further equal to or larger than 1.8 mm.

9. The plastic bezel of claim 8, wherein each of the bosses has an outer diameter and an inner diameter, the outer diameter is equal to or larger than 8.4 mm, and the inner diameter is equal to or smaller than 4.8 mm.

10. The plastic bezel of claim 9, wherein each of the bosses has a wall height relative to the plate body, and the wall height is equal to or larger than 4.2 mm.
